(19) United States
(12) Patent Application Publication
(10) Pub. No.: US 2014/0189486 A1
(43) Pub. Date: Jul. 3, 2014

(54) Non-Transitory Computer Readable Medium Storing Document Sharing Program, Terminal Device and Document Sharing Method

(71) Applicant: Mizuho Yasoshima, Nagoya-shi (JP)

(72) Inventor: Mizuho Yasoshima, Nagoya-shi (JP)

(73) Assignee: BROTHER KOGYO KABUSHIKI KAISHA, Nagoya-shi (JP)

(21) Appl. No.: 14/141,475

(22) Filed: Dec. 27, 2013

(30) Foreign Application Priority Data
Dec. 27, 2012 (JP) 2012-284640

(51) Int. Cl. G06F 17/24; G06F 3/0484; H04L 29/06; G06F 3/0481

(52) U.S. Cl. CPC G06F 17/241; G06F 3/0481; G06F 3/04845; H04L 65/403
USPC 715/232

(57) ABSTRACT

A non-transitory computer-readable medium stores instructions executed by a processor of a terminal device to perform following processes. The processor acquires data indicating a document shared between a plurality of terminal devices, and displays, on a display device of the terminal device, a display range indicating at least a portion of the document. The processor receives annotation data indicating an annotation superimposed on the document in another terminal device, and determines whether the annotation is inside the display range in the document. If the annotation is not inside the display range, the processor displays a marker indicating that the annotation data has been received. The processor determines whether operation information acquired from an operation device of the terminal device indicates an operation targeting the marker. If the acquired operation information indicates the operation targeting the marker, the processor changes the display range to include the annotation inside the display range.

### CROSS-REFERENCE TO RELATED APPLICATION

This Application claims priority to Japanese Patent Application No. 2012-284640, filed on Dec. 27, 2012, the content of which is hereby incorporated by reference.

### BACKGROUND

The present disclosure relates to a medium storing a document sharing program that can be executed by a computer of a terminal device that performs transmission and reception of various data with a plurality of terminal devices that are connected via a network, and also relates to a terminal device and a document sharing method.

Programs, such as remote conference products, are known that are used to share a document between a plurality of terminal devices via a network. These programs are executed by a computer of each of terminal devices, such as a personal computer, a smart phone, a tablet terminal and the like. A user of each of the terminal devices can cause the shared document to be displayed on a display device and can perform a remote conference or operations etc. while referring to the document. Sizes and resolutions of the display devices of these terminal devices are different for each of the terminal devices. Therefore, users of some of the terminal devices can read the document even when the whole of the document is displayed on the display device as a display range. However, there is a possibility that users of the other terminal devices cannot read the document because of the size of the display device when the whole of the document is displayed on the display device as the display range. In this case, the users can read the document by enlarging the document such that a section of the document is within the display range.

There is a display method in which, when a first user adds an annotation etc. to the document, a range that is common to the display range of the document in another terminal device can be shown on the display device. With this display method, when the first user adds an annotation within that range, a second user that uses the other terminal device can refer to the annotation without changing the display range.

### SUMMARY

However, when at least one of the users enlarges the document, there is a possibility that an area that is not common is generated in the display range of the document in each of the terminal devices. For example, when the position to which the first user adds the annotation is outside the display range of the terminal device of the second user, the second user may not notice that the annotation has been added to the document. In this type of case, the computer of the terminal device may display the whole document on the display device as the display range so that the second user can refer to the annotation. However, as the whole document is displayed regardless of the fact that the second user has enlarged the document in order to read it, the reading of the document is stopped. After referring to the annotation that has been scaled down and displayed together with the document, the second user has to perform an operation to enlarge and display the document in order to return the display of the display device to the original display range, which is troublesome.

The present disclosure has been made to solve the above-described problems, and provides a medium storing a document sharing program that causes a computer to execute processing that displays on a display device a marker indicating reception of annotation data when a position of an annotation added to a document in another terminal device is outside a display range, a terminal device and a document sharing method.

An aspect of the present disclosure provides a non-transitory computer-readable medium storing computer-readable instructions. The instructions, when executed by a processor of a terminal device, perform processes comprise an acquiring operation, a first displaying operation, a receiving operation, a first determining operation, a second displaying operation, and a changing operation. The acquiring operation acquires document data indicating a document being shared between a plurality of terminal devices in a remote conference. The first displaying operation displays, on a display device of the terminal device, a display range indicating at least a portion of the document corresponding to the acquired document data. The receiving operation receives annotation data from at least one of the plurality of terminal devices. The annotation data indicates an annotation superimposed on the document in the at least one of the plurality of terminal devices. The first determining operation determines whether a position of the annotation corresponding to the received annotation data is inside the display range in the document. The second displaying operation displays, in response to the determination by the first determining operation that the position of the annotation is not inside the display range, a marker on the display device. The marker indicates that the annotation data has been received by the receiving operation. The second determining operation determines whether operation information acquired from an operation device of the terminal device indicates an operation targeting the marker. The changing operation changes, in response to the determination by the second determining operation that the acquired operation information indicates the operation targeting the marker, the display range to include the annotation inside the display range.

Another aspect of the present disclosure provides a terminal device comprises a processor and a memory. The memory stores computer-readable instructions. The instructions, when executed by the processor, perform processes comprises an acquiring operation, a first displaying operation, a receiving operation, a first determining operation, a second displaying operation, and a changing operation. The acquiring operation acquires document data indicating a document being shared between a plurality of terminal devices in a remote conference. The first displaying operation displays, on a display device of the terminal device, a display range indicating at least a portion of the document corresponding to the acquired document data. The receiving operation receives annotation data from at least one of the plurality of terminal devices. The annotation data indicates an annotation superimposed on the document in the at least one of the plurality of terminal devices. The first determining operation determines whether a position of the annotation corresponding to the received annotation data is inside the display range in the document. The second displaying operation displays, in response to the determination by the first determining operation that the position of the annotation is not inside the display range, a marker on the display device. The marker indicates that the annotation data has been received by the receiving operation. The second determining operation determines whether operation information acquired from an operation device of the terminal device indicates an operation targeting the marker. The changing operation changes, in response to the determination by the second determining operation that the acquired operation information indicates the operation targeting the marker, the display range to include the annotation inside the display range.

Yet another aspect of the present disclosure provides a document sharing method. The document sharing method comprises acquiring, first displaying, receiving, first determining, second displaying, second determining, and changing. The acquiring acquires document data indicating a document being shared between a plurality of terminal devices in a remote conference. The first displaying displays, on a display device of the terminal device, a display range indicating at least a portion of the document corresponding to the acquired document data. The receiving receives annotation data from at least one of the plurality of terminal devices. The annotation indicates an annotation superimposed on the document in the at least one of the plurality of terminal devices. The first determining determines whether a position of the annotation corresponding to the received annotation data is inside the display range. The second displaying displays, in response to the determination by the first determining that the position of the annotation is not inside the display range, a marker on the display device. The marker indicates that the annotation data has been received by the receiving. The second determining determines whether operation information acquired from an operation device of the terminal device indicates an operation targeting the marker. The changing changes, in response to the determination by the second determining that the acquired operation information indicates the operation targeting the marker, the display range to include the annotation inside the display range.

### BRIEF DESCRIPTION OF THE DRAWINGS

Embodiments of the disclosure will be described below in detail with reference to the accompanying drawings in which:

FIG. 1 is a diagram showing a schematic configuration of a system that is constructed by terminal devices in which a document sharing program is installed, and an electrical configuration of a smart phone 1;

FIG. 2 is a diagram showing a state of a document 5 that is displayed on a display 16;

FIG. 3 is a diagram showing a state of the document 5 that is displayed on a monitor 41;

FIG. 4 is a diagram showing a state of the document 5 that is enlarged and displayed on the display 16;

FIG. 5 is a flowchart showing marker display processing of the document sharing program;

FIG. 6 is a flowchart showing annotation adding processing of the document sharing program;

FIG. 7 is a flowchart showing annotation direction display processing of the document sharing program;

FIG. 8 is a diagram showing a manner in which a user performs an operation on a marker 65; and

FIG. 9 is a diagram showing a state in which a display range of the document 5 is changed to a position where the display range includes an annotation 55.

### DETAILED DESCRIPTION

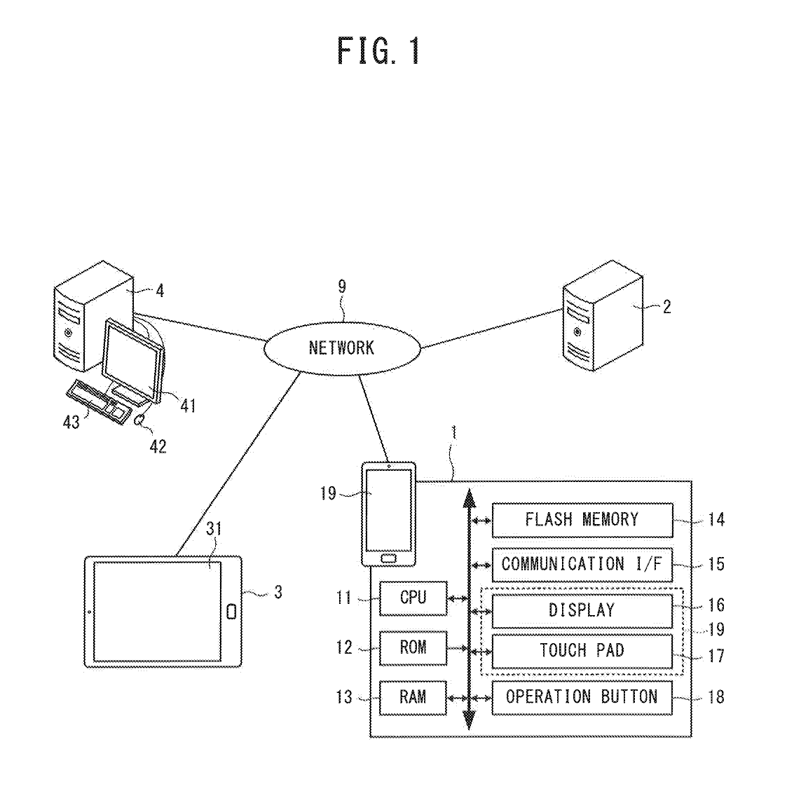

Hereinafter, an embodiment of the present disclosure will be explained with reference to the drawings. A system that is configured by terminal devices in which a document sharing program according to the present disclosure is installed will be explained with reference to FIG. 1. In the present embodiment, a smart phone 1, a tablet terminal 3 and a personal computer (hereinafter referred to as a “PC”) 4 shown in FIG. 1 that have known structures are used as an example of the terminal devices. The smart phone 1 and the tablet terminal 3 include a touch panel 19 and a touch panel 31, respectively. A display device and an input device are integrated in the touch panel 19 and in the touch panel 31. The PC 4 includes a monitor 41 as a display device, and includes a mouse 42 and a keyboard 43 as input devices. The smart phone 1, the tablet terminal 3 and the PC 4 can be connected via a network 9 such that they can communicate with each other. A server 2, which is constructed using a PC with a known structure, is connected to the network 9. The server 2 constructs a system in which a document (which will be described later) can be shared between the terminal devices. Computers of the smart phone 1, the tablet terminal 3 and the PC 4 log in to the system. Document data that indicates a document is transmitted to the server 2 from the smart phone 1, the tablet terminal 3 or the PC 4. The server 2 transmits the received document data to each of the terminal devices that have logged in, via the network 9. Each of the smart phone 1, the tablet terminal 3 and the PC 4 performs the document sharing program using their respective computers, and displays on their respective display devices the document data received from the server 2. With the above-described processing, the document sharing between each of the terminal devices is achieved. Note that the document data may be stored in advance in a storage device (not shown in the drawings) that is provided in the server 2. Note that, annotation data that indicates an annotation (which will be described later) is also transmitted to the server 2 in a similar manner from the terminal device into which the annotation is input. Then, the server 2 that has received the annotation data transmits the annotation data to each of the terminal devices that have logged in. Thus, it is possible to display the annotation for the document that is being shared by each of the terminal devices. Note that the annotation data may be transmitted and received by direct communication between the terminal devices.

The document sharing program (which will be described later) is stored in the storage device of the server 2. The computer of each of the smart phone 1, the tablet terminal 3 and the PC 4 that are logged in to the server 2 via the network 9 can download and install the document sharing program. Note that, when a server for program download is provided separately from the server 2, the computer of each of the terminal devices can download and install the document sharing program from the server for program download. The document sharing program is compiled into a code in accordance with each of the terminal devices and is supplied. A display method of the document and an operation method of the document in each of the terminal devices are determined in accordance with an input/output device of each of the terminal devices, and therefore they may be different for each of the terminal devices. However, as the computer of each of the terminal devices executes the document sharing program, the display method and the operation method are substantially the same between the terminal devices. Hereinafter, for the sake of convenience, attention is focused on the smart phone 1, and an electrical configuration of the smart phone 1 and operations arising from the execution of the document sharing program will be explained.

The smart phone 1 is provided with a CPU 11 that performs overall control of the smart phone 1. The CPU 11 is electrically connected to a ROM 12, a RAM 13, a flash memory 14, a communication interface (hereinafter referred to as a “communication I/F”) 15, a display 16, a touch pad 17 and an operation button 18. The ROM 12 stores a boot program, a basic input/output system (BIOS) and the like. The RAM 13 stores a timer, a counter and temporary data etc. The flash memory 14 stores a control program of the CPU 11. The document sharing program that will be described later is stored in the flash memory 14.

The communication I/F 15 is an interface to perform wireless communication using a wireless LAN, such as WiFi (registered trade mark), or using a communication standard, such as 3G, long term evolution (LTE) or 4G. The smart phone 1 is connected to an access point (not shown in the drawings) of the network 9. The smart phone 1 communicates via the network 9 with the server 2, the tablet terminal 3 and the PC 4 that are also connected to the network 9. The smart phone 1 may directly communicate with the server 2, the tablet terminal 3 and the PC 4 using a wireless LAN without going through the network 9. Further, the communication I/F 15 may be an interface that performs wired communication.

The display 16 is a display device, such as a liquid crystal panel, for example. The display 16 has a size in which, for example, the length of the diagonal of its screen is 4 inches and the aspect ratio is 16:9. Note that the display 16 may be a display device using another display method, such as an organic electro-luminescence display. The touch pad 17 detects a position touched by a finger or the like of a user. The touch pad 17 is, for example, an electrostatic capacity type position detecting device. Note that the touch pad 17 may be a position detecting device using another detection method, such as a pressure sensitive touch pad. The display 16 and the touch pad 17 are formed to be substantially the same size. The touch panel 19 is formed by placing the touch pad 17 on the display 16. The operation button 18 is a physical switch that can be used by the user to perform an input operation on the smart phone 1, as well as using the touch pad 17. In the present embodiment, the operation button 18 is used to terminate the document sharing program (to terminate an application) that is being executed.

The CPU 11 of the smart phone 1 configured as described above executes the document sharing program, communicates with the server 2, the tablet terminal 3 and the PC 4 via the network 9, and shares the document via the server 2. The document is, for example, a text, a graphic, a chart, a graph, an image or video, or information structured by a combination of the above. The document is content that is displayed on the display device (the display 16 of the smart phone 1, for example) by the computer of the terminal device (the CPU 11 of the smart phone 1, for example) and can thus be viewed by the user. The document is indicated by the document data, which is data in a format that can be handled by the computer. The document data is transmitted from the server 2 to the terminal device and is stored in the storage device of the terminal device (the flash memory 14 of the smart phone 1, for example).

When the document sharing program (which will be described later) is executed, the computer of the terminal device performs reception processing of the document data, display processing of the document based on the document data, processing in accordance with an operation performed on the document by the user, and the like. Further, the computer performs processing relating to addition of an annotation to the document by the user of the terminal device. Each of the terminal devices shares the annotation in addition to the document. As these processes are known, operations of the terminal device relating to document viewing and annotation addition will be briefly explained below using the smart phone 1 as an example. Note that, in the present embodiment, the computer performs processing that displays a marker that indicates that an annotation has been added to the document. Processing relating to the display of the marker will be explained in detail using the smart phone 1 as an example when explaining a flowchart of the document sharing program (which will be described later).

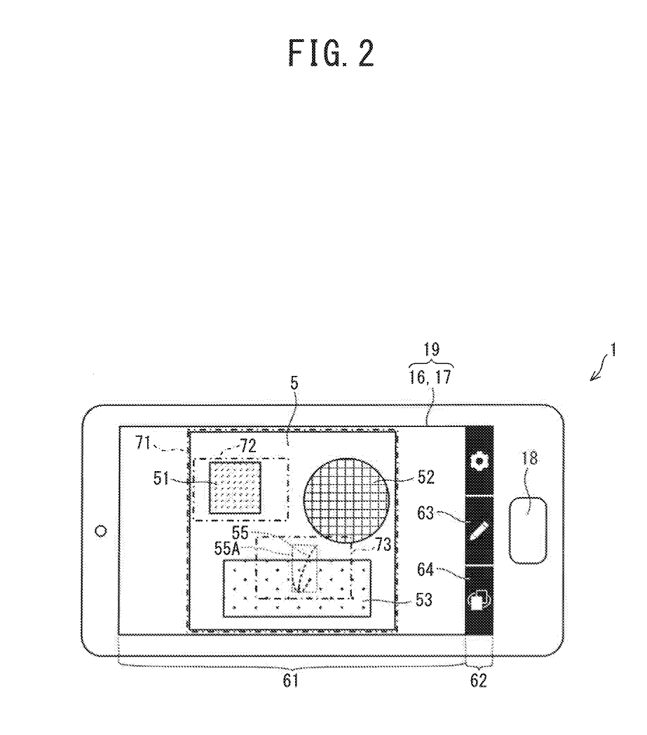

The document based on the document data is displayed on the display device of each of the terminal devices. For example, as shown in FIG. 2, in accordance with the execution of the document sharing program, the CPU 11 of the smart phone 1 sets, on the display 16, a display area 61 in which a document 5 can be displayed, and an operation area 62 to receive an input of an operation by the user. The CPU 11 reads the document data from the flash memory 14 and displays the document 5 based on the document data in the display area 61. Note that the operation area 62 is provided with, for example, an add button 63 that is used to shift to a mode in which an annotation is added to the document 5, and a switch button 64 that is used to switch the document 5 displayed in the display area 61 to another document.

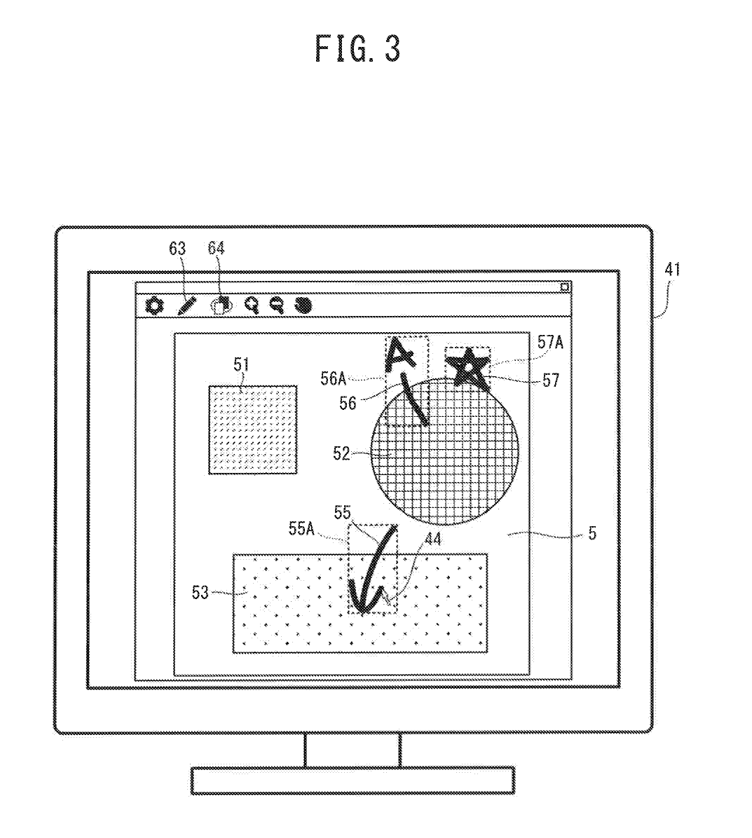

The document 5 is a substantially square drawing in which, for example, three graphics 51, 52 and 53 are drawn on the plane without overlap. In the document 5, the graphics 51 and 52 are respectively arranged in an upper left section and an upper right section with respect to the center of the document 5. The graphic 53 is arranged lower than the center of the document 5. A section of the document 5 that is set as a display range is displayed in the display area 61 of the display 16. As shown in FIG. 2, when the whole of the document 5 is set as a display range 71 that is shown by dotted lines in the figure, the whole of the document 5 is displayed such that the display range 71 is included in the display area 61 of the display 16. Similarly, as shown in FIG. 3, a CPU (not shown in the drawings) of the PC 4 can display, on the monitor 41, the document 5 that is based on the document data. The monitor 41 has a size in which, for example, the length of the diagonal of its screen is 19 inches and the aspect ratio is 4:3. Therefore, the user of the PC 4 can read details of the document 5 that appears on the monitor 41 without enlarging and displaying the document 5.

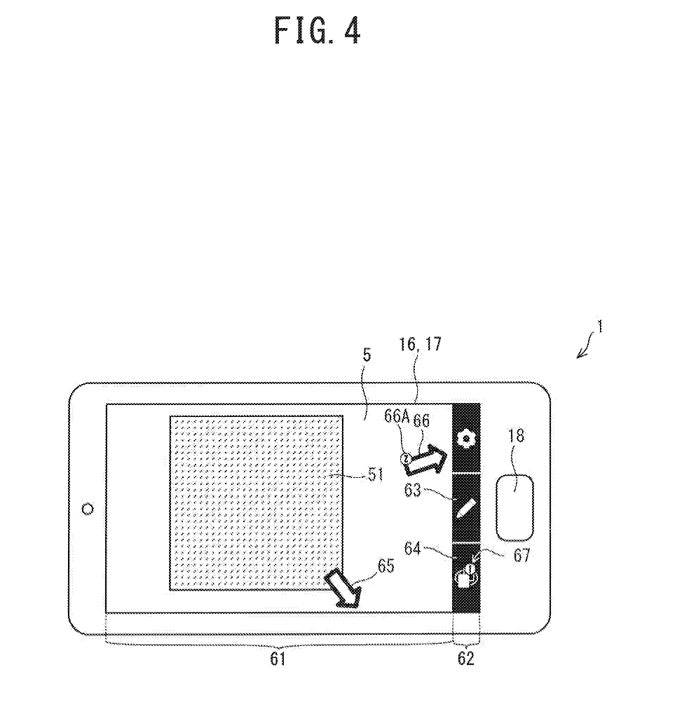

On the other hand, the display 16 of the smart phone 1 is smaller than the monitor 41 of the PC 4. As described above, the display 16 of the smart phone 1 is formed such that the length of the diagonal of its screen is 4 inches, for example. As shown in FIG. 2, when the whole of the document 5 is set as the display range 71 and the whole of the document 5 is displayed within the display area 61 of the display 16, it may be difficult for the user of the smart phone 1 to read the details of the document 5. In this type of case, the user touches the touch pad 17 with his/her fingers and performs a known pinch operation that changes, for example, the display range 71 that includes the whole of the document 5 to a display range 72 (shown by dotted lines in FIG. 2) that includes only the graphic 51. The pinch operation is, for example, an operation in which the user touches the touch pad 17 with two of his/her fingers and changes the distance between the two fingers on the touch pad 17. As shown in FIG. 4, the CPU 11 of the smart phone 1 detects the operation of the user based on position detection by the touch pad 17 and displays, in the display area 61, a section of the document 5 that is within the display range 72 (refer to FIG. 2). Thus, the CPU 11 can enlarge and display the graphic 51 of the document 5 on the display 16. Further, when the user performs a known flick operation or swipe operation, the CPU 11 can scroll the document 5 in the display area 61 by changing the position of the display range 72 in the document 5 in accordance with the operation while maintaining the enlarged display of the graphic 51 of the document 5. The flick operation or the swipe operation is, for example, an operation in which the finger that is in contact with the touch pad 17 is moved on the touch pad 17. An operation signal generated by the operation of the touch pad 17 is processed by a module included in an OS that is installed in the smart phone 1, and is converted into position information and operation identification information. The position information indicates a position on which the operation is performed. The operation identification information identifies a type of the operation (for example, pinch operation, flick operation, or swipe operation). The CPU 11 that executes the document sharing program acquires the position information and the operation identification information from the OS via an API.

As described above, the user of each of the terminal devices can add an annotation to the document. The annotation is information that is drawn on the document displayed on the screen by the user of the terminal device using the input device (the touch pad 17, the mouse 42, the keyboard 43 or the like). The computer of the terminal device displays the annotation as a layer that is overlaid on the document. When the user adds the annotation to the document, the computer obtains position information of the drawn annotation in the document, and generates annotation data in which image data of the drawn annotation and the position information are associated with the document. The annotation data may include identification information of the associated document (e.g., a file name, an ID of the document data), the position information, and the image data. The position information may indicate a position in the document (i.e., the same coordinate system as the document) and/or a position in the annotation data itself (i.e., a different coordinate system from the document). The computer of the terminal device that has generated the annotation data transmits the annotation data simultaneously to the other terminal devices via the server 2. The computer creates a table (not shown in the drawings) in the storage device (the flash memory 14 in the case of the smart phone 1) when the computer executes the document sharing program. The computers of the other terminal devices that have received the annotation data each store the received annotation data in the table in an order of reception. Each of the annotation data is associated with a flag (a reception flag) that indicates that the annotation data has been newly received and a flag (a non-display flag) that indicates that the annotation has not been displayed, and is stored in the table.

For example, as shown in FIG. 3, the CPU (not shown in the drawings) of the PC 4 displays the document 5 on the monitor 41 in accordance with the execution of the document sharing program. The user of the PC 4 can draw an annotation 55 on the document 5 by moving a cursor 44 by operating the mouse 42 (refer to FIG. 1) and then clicking the add button 63. For example, the annotation 55 is drawn from a blank section below and to the left of the graphic 52 of the document 5 to the vicinity of the center of the graphic 53. The CPU of the PC 4 obtains position information, in the document 5, of an annotation area 55A that shows an area in which the annotation 55 is drawn. Note that, in the present embodiment, the annotation area is shown by a rectangle that circumscribes the annotation, and the position information is represented by coordinates of four corner points of the rectangle obtained based on the document. Specifically, for example, the CPU of the PC 4 uses the upper left corner point of the document 5 as the reference (origin), and represents the whole of the document 5 by an X-Y coordinate system. The CPU of the PC 4 calculates coordinates of each of the four corner points of the annotation area 55A on the document 5, and the coordinates are obtained as the position information. The CPU of the PC 4 associates the image data of the drawn annotation 55 and the obtained position information with the document 5 to which the annotation 55 is to be added, and thus generates the annotation data. The CPU of the PC 4 transmits the annotation data to the other terminal devices, namely, the smart phone 1 and the tablet terminal 3, via the server 2. More specifically, the CPU of the PC 4 transmits the annotation data to the server 2 via the network 9. The server 2 transmits the annotation data received from the PC 4 to the other terminal devices.

The user can freely add annotations to a plurality of documents, respectively. Further, the user can add a plurality of annotations to one document. For example, when the user adds annotations 56 and 57 to the document 5, respectively, the CPU of the PC 4 associates position information of annotation areas 56A and 57A and image data of the annotations 56 and 57 with the document 5, and thus respectively generates the annotation data. The CPU of the PC 4 transmits each of the generated annotation data to the other terminal devices via the server 2. For example, the annotation 56 is drawn from above and to the left of the graphic 52 to an upper left section of the graphic 52. For example, the annotation 57 is drawn in a blank section such that the annotation 57 slightly overlaps with an upper right section of the graphic 52.

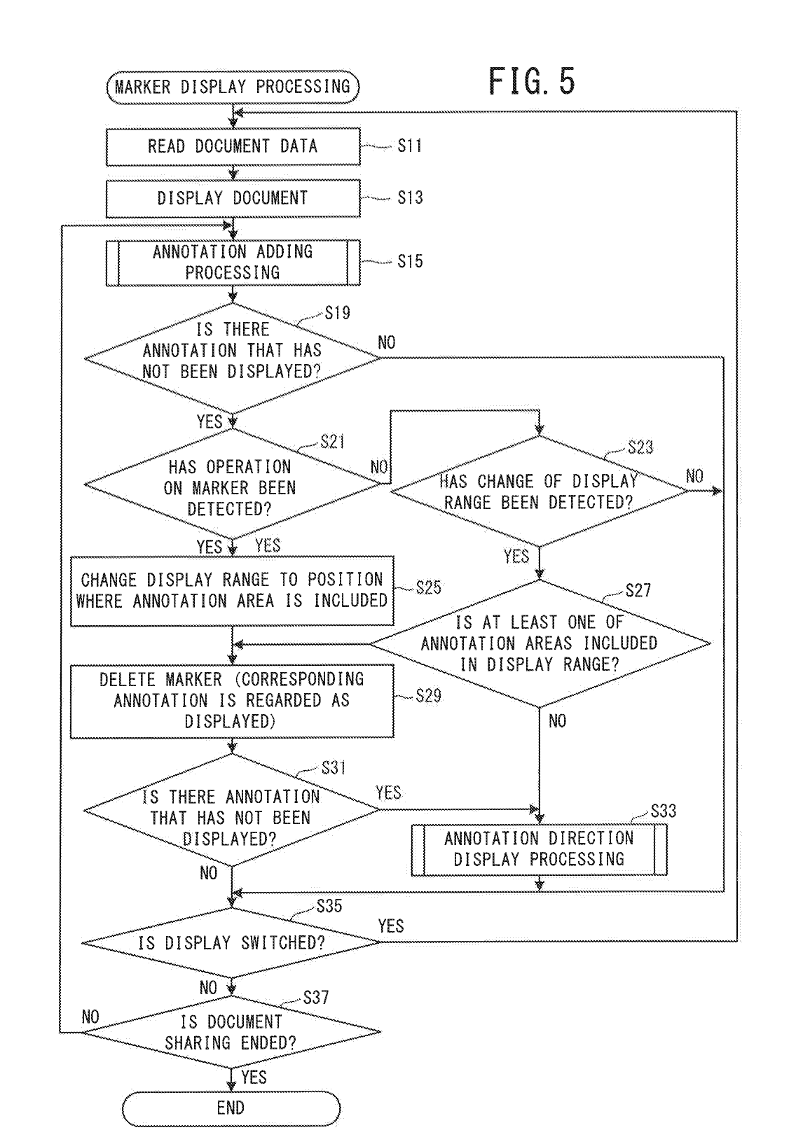

Next, a series of processing relating to the display of the marker that indicates that an annotation has been added to the document will be explained with reference to flowcharts shown in FIG. 5 to FIG. 7, using processing performed by the CPU 11 of the smart phone 1 as an example. Marker display processing shown in FIG. 5 is one of modules whose processing is started when the CPU 11 of the smart phone 1 executes the document sharing program based on a user's operation. As described above, the CPU 11 sets the display area 61 and the operation area 62 on the display 16, reads the document data from the flash memory 14 (step S11). The CPU 11 transmits the read document data to the other terminal devices (the PC 4, for example) that share the document via the server 2. Note that, in a case where document data stored in the other terminal device is shared, the CPU 11 receives the document data via the server 2 at step S11. The CPU 11 displays the document based on the document data in the display area 61 (step S 13). The identification information of the displayed document data is stored in the RAM 13. Note that, when there are a plurality of documents, the CPU 11 performs processing that allows the user to select a document to be displayed (the document 5, for example) when the document data is read at step S11. Further, the above-described series of processing (such as processing in accordance with the user's operation on the displayed document) that relates to the document viewing is carried out by the CPU 11 executing other modules (not shown in the drawings) of the document sharing program. Note that, as shown in FIG. 4, it is assumed that the document 5 in which the display range 72 (refer to FIG. 2) is set by enlarged display is displayed on the display 16 of the smart phone 1.

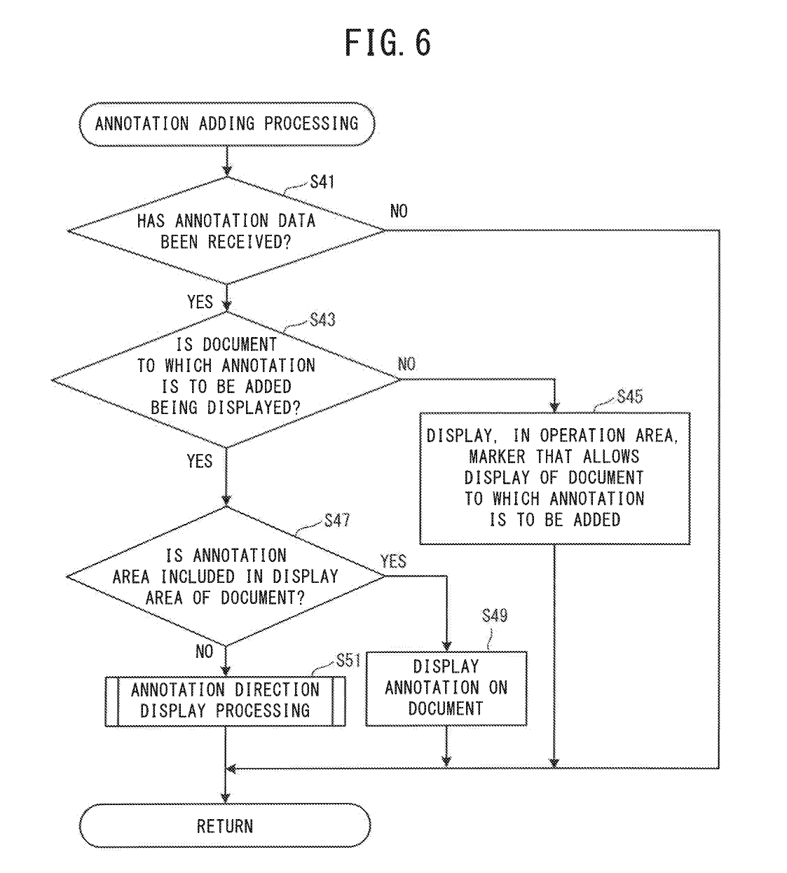

As shown in FIG. 5, the CPU 11 performs a sub-routine of annotation adding processing (step S 15). As described above, the annotation data is stored in the table (not shown in the drawings) of the flash memory 14 in the order of reception from the other terminal devices. As shown in FIG. 6, in the annotation adding processing, the CPU 11 refers to the table stored in the flash memory 14 and determines whether the annotation data has been newly received, based on a state of the reception flag (step S41). When the annotation data has not been newly received and there is no annotation data for which the reception flag is ON (no at step S41), the CPU 11 returns the processing to the marker display processing shown in FIG. 5.

On the other hand, when the annotation data has been newly received at step S41 and there is the annotation data for which the reception flag is ON (yes at step S41), the CPU 11 determines whether the document that is associated with the annotation data is the document 5 displayed in the processing at step S13 (step S43). Specifically, the CPU 11 determines whether the identification information of the document data that is associated with the annotation data that is stored in the table of the flash memory 14 matches the identification information of the document that is being displayed and that is stored in the RAM 13. When the annotation based on the newly received annotation data is not the annotation corresponding to the document 5 that is being displayed (no at step S43), the CPU 11 displays a marker 67 (refer to FIG. 4) that indicates the reception of the annotation data on the switch button 64 in the operation area 62 (step S45). As shown in FIG. 4, in the present embodiment, the CPU 11 can display on the switch button 64 a graphic to which a number is affixed. The CPU 11 increments the number of the marker 67 by one every time the processing at step S45 is performed. By this processing, the CPU 11 not only notifies the user that the annotation data corresponding to a document different from the document 5 that is being displayed has been received, but also can notify the number of the annotation data to the user. When the marker 67 is displayed, the CPU 11 turns off the reception flag of the annotation data and returns the processing to the marker display processing shown in FIG. 5.

On the other hand, in the processing at step S43, when the annotation based on the newly received annotation data is the annotation corresponding to the document 5 that is being displayed (yes at step S43), the CPU 11 determines whether the annotation area is included in the display range of the document (step S47). The CPU 11 acquires position information of the annotation area that is included in the annotation data stored in the flash memory 14. As described above, the position information of the annotation area is indicated by the coordinates of the four corner points of the annotation area on the basis of the document 5. The display range is also indicated by the coordinates of the four corner points on the basis of the document 5. Base on the position information, the CPU 11 obtains the position where the annotation area is located on the document 5 that is currently enlarged and displayed. When the position of the annotation area is included in the display range 72 of the document 5 that is currently displayed (yes at step S47), the CPU 11 displays, as a layer that is overlaid on the document 5, the annotation based on the annotation data (step S49). That is, the annotation is displayed in the display area 61 of the display 16 of the smart phone 1. After displaying the annotation, the CPU 11 turns off both the reception flag and the non-display flag of the annotation data, and returns the processing to the marker display processing shown in FIG. 5.

For example, it is assumed that the CPU 11 has newly received the annotation data of the annotation 55 (refer to FIG. 2) in the processing at step S41. As described above, the annotation 55 is drawn from below and to the left of the graphic 52 to the vicinity of the center of the graphic 53. Therefore, the annotation area 55A of the annotation 55 is not included in the display range 72. When the annotation area is not included in the display range 72 of the document (no at step S47), the CPU 11 performs a sub-routine of annotation direction display processing (step S51).

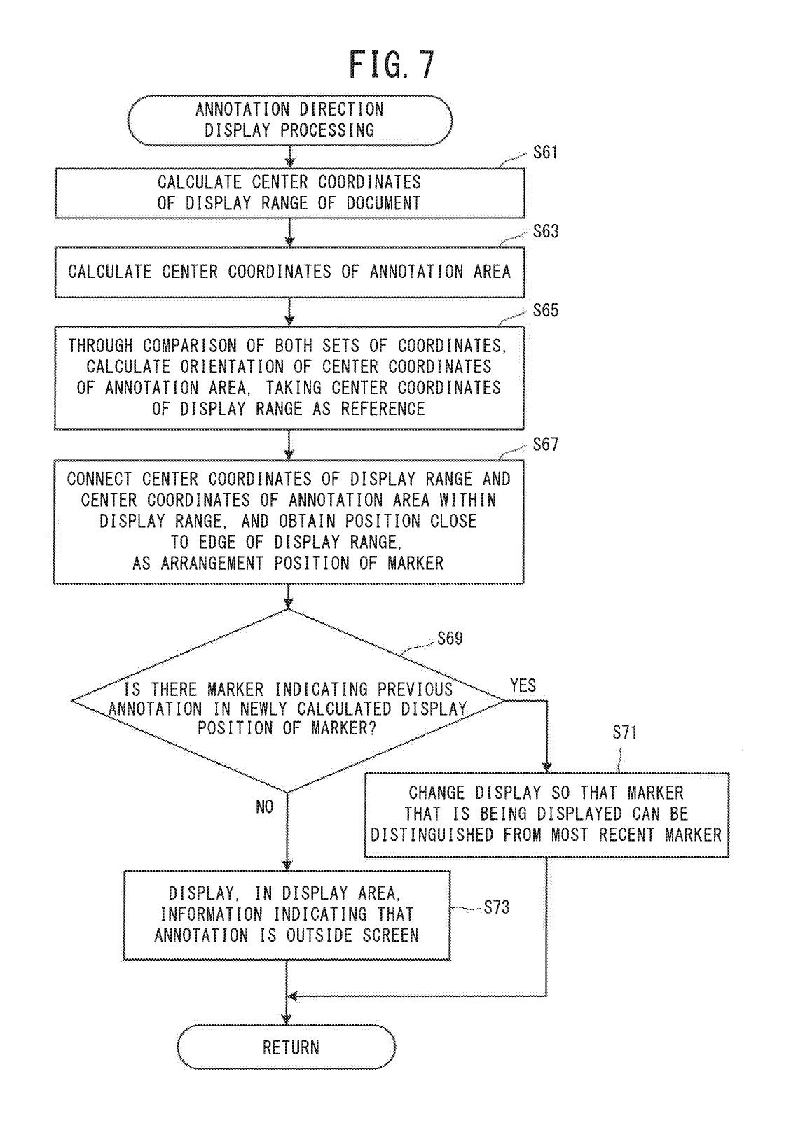

As shown in FIG. 7, in the annotation direction display processing, the CPU 11 adds all the values of the coordinates of the four corner points of the display range 72 in the document 5. The CPU 11 calculates the average value by dividing the sum of the coordinate values by four, and obtains the center coordinates of the display range 72 (step S61). Similarly, the CPU 11 adds all the values of the coordinates of the four corner points of the annotation area 55A, calculates the average value by dividing the sum of the coordinate values by four, and obtains the center coordinates of the annotation area 55A (step S63). The CPU 11 performs a calculation that subtracts the values of the center coordinates of the display range 72 from the values of the center coordinates of the annotation area 55A, and thereby obtains the coordinates of a vector that indicates the direction in which the center coordinates of the annotation area 55A are oriented, taking the center coordinates of the display range 72 as a reference (step S65). The CPU 11 stores, in the RAM 13, the coordinates of the vector indicating the direction of the annotation area obtained by the above-described calculation.

The CPU 11 connects the center coordinates of the display range 72 and the center coordinates of the annotation area 55 within the display range 72, and determines a position that is close to the edge of the display range 72, as an arrangement position of a marker 65 (step S67). Specifically, the CPU 11 calculates an intersection point at which a line segment that connects the center coordinates of the display range 72 and the center coordinates of the annotation area 55A and one of line segments that connect the four corner points of the display range 72. The CPU 11 calculates coordinates of a position which has moved, on the line segment connecting the center coordinates of the display range 72 and the center coordinates of the annotation area 55A, from the intersection point toward the center coordinates of the display range 72 by a predetermined distance that is set in advance. The CPU 11 determines the position of the calculated coordinates as the position on which to arrange the marker 65 that indicates that the annotation data of the annotation 55 has been received.

When another marker has not yet been arranged in the determined position (no at step S69), the CPU 11 displays in the determined position, as the marker 65, a graphic of an arrow that is directed from the center coordinates of the display range 72 to the center coordinates of the annotation area 55A (step S73). More specifically, the CPU 11 displays, as the marker 65, the graphic of the arrow that points in the direction based on the coordinates of the vector indicating the direction of the annotation area that is obtained by the processing at step S65. After displaying the marker 65, the CPU 11 turns off the reception flag of the annotation data and returns the processing to the marker display processing shown in FIG. 5.

Further, it is assumed that the annotation data of the annotation 56 (refer to FIG. 3), for example, has already been received before the CPU 11 performs the processing at step S69, and the annotation data of the annotation 57 (refer to FIG. 3) has been newly received in a state in which the marker display has been performed for the annotation 56. As described above, the annotations 56 and 57 are both drawn from the blank section above the graphic 52. A marker 66 that indicates the reception of the annotation data of the annotation 56 is shown by a graphic of an arrow which is directed from the center coordinates of the display range 72 toward the center coordinates of the annotation area 56A and which connects the two sets of center coordinates, and is arranged in a position that is close to the edge of the display range 72 (refer to FIG. 4). As the position of the center coordinates of the annotation area 57A, taking the center coordinates of the display range 72 as the reference, is close to the position of the center coordinates of the annotation area 56A, the CPU 11 determines that an arrangement position of a marker indicating that the annotation data of the annotation 57 has been received is set to almost the same position as the marker 66. Therefore, as the marker 66 indicating the reception of the annotation 56 has already been arranged in the arrangement position of the marker indicating the reception of the annotation 57 (yes at step S69), the CPU 11 advances the processing to step S71. In order to notify the user of the reception of the new annotation 57, the CPU 11 overlays and displays an additional marker 66A on the marker 66 (step S71). The additional marker 66A is a graphic to which a number is affixed. After the CPU 11 displays the additional marker 66A, the CPU 11 turns off the reception flag of the annotation data and returns the processing to the annotation adding processing shown in FIG. 6. In the annotation adding processing shown in FIG. 6, the CPU 11 further returns the processing to the marker display processing shown in FIG. 5.

In the marker display processing shown in FIG. 5, the CPU 11 advances the processing to step S19. The CPU 11 refers to the table of the flash memory 14 and determines whether there is the annotation based on the annotation data that has not yet been displayed, based on a state of the non-display flag (step S19). When it is determined that there is no annotation data for which the non-display flag is ON (no at step S19), the CPU 11 advances the processing to step S35. When the user touches the touch pad 17 with his/her finger or the like and operates the switch button 64 (yes at step S35), the CPU 11 once again turns on the reception flag of the annotation data for which the non-display flag is ON, among the annotation data stored in the table of the flash memory 14. The CPU 11 returns the processing to step S11, reads other document data from the flash memory 14 (step S11), and displays the other document data in the display area 61 of the display 16 (step S13). In the annotation adding processing (step S15, FIG. 6), the reception flag of the annotation data that has not been displayed is again ON. Therefore, the CPU 11 performs marker display in accordance with a position of an annotation that corresponds to the other document to which the display has been switched.

When there is no operation by the user in the processing at step S35, or when the operation performed by the user is not the operation of the switch button 64 (no at step S35), the CPU 11 advances the processing to step S37. When the user depresses the operation button 18 (yes at step S37), the CPU 11 ends the execution of the document sharing program. When the operation button 18 is not operated (no at step S37), the CPU 11 returns the processing to step S15.

On the other hand, in the processing at step S19, when there is the annotation data for which the non-display flag is ON and there is the annotation based on the annotation data that has not been displayed (yes at step S 19), the CPU 11 detects the user's operation based on position detection by the touch pad 17 (step S21). When there is no operation by the user, or when the operation performed by the user is not the operation that is associated with the marker 65 or 66 (no at step S21), the CPU 11 advances the processing to step S23. Further, the CPU 11 determines whether the detected user's operation is a flick operation or a swipe operation that is performed by the user to change the position of the display range 72 (step S23). When it is determined that the user's operation is not the operation to change the position of the display range 72 (no at step S23), the CPU 11 advances the processing to step S35, and repeats the processing in the same manner as that described above.

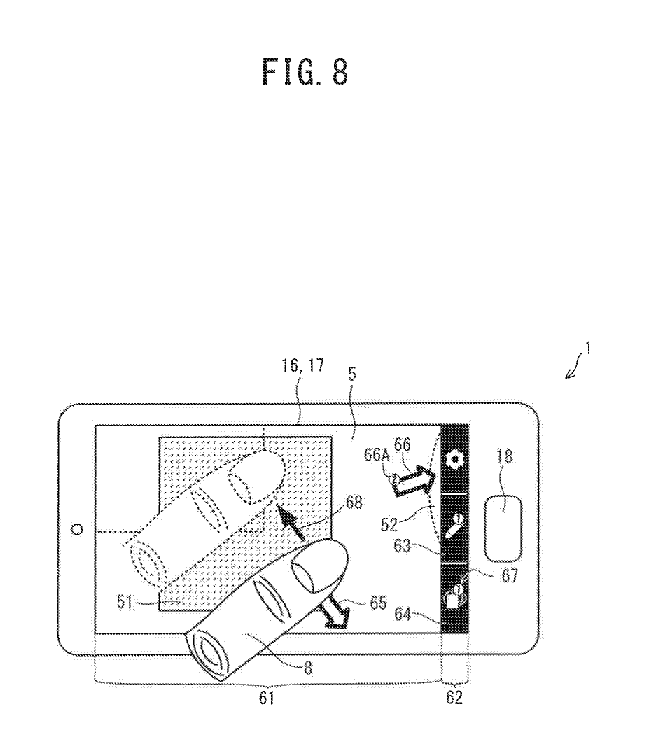

In the processing at step S21, when the detected user's operation is the operation that is associated with the marker 65 or 66 (yes at step S21), the CPU 11 advances the processing to step S25. As described above, the marker 65 is the graphic of the arrow that is directed from the center coordinates of the display range 72 of the document 5 displayed on the display 16 toward the center coordinates of the annotation area 55A. The marker 66 is the graphic of the arrow that is directed from the center coordinates of the display range 72 toward the center coordinates of the annotation areas 56A and 57A. As shown in FIG. 8, the user touches the touch pad 17 with a finger 8 and performs a flick operation (or a swipe operation) that can change the position of the display range 72 (refer to FIG. 2) of the document 5 that is displayed on the display 16. In the present embodiment, in a state in which the markers 65 and 66 are displayed in the display area 61 of the display 16, when an operation direction 68 of the flick operation by the finger 8 of the user is substantially 180 degrees in the opposite direction to the direction indicated by the arrow of the marker 65 or the marker 66, the flick operation is associated with the operation on the marker 65 or 66.

In FIG. 8, the user performs the flick operation in which the user moves the finger 8 in the direction opposite to the direction indicated by the arrow of the marker 65. The flick operation is generally an operation in which the section of the document 5 displayed within the current display range 72 is moved in the operation direction 68 and a new display range of the document 5 is set in the direction indicated by the arrow of the marker 65. On the condition that the operation direction 68 of the flick operation is substantially 180 degrees in the opposite direction to the direction indicated by the arrow of the marker 65, the CPU 11 detects that the flick operation is an operation on the marker 65. Note that the CPU 11 may detect the flick operation as the operation on the marker 65 if the operation direction 68 of the flick operation is within a predetermined angle range that is set in advance taking the direction indicated by the arrow of the marker 65 as a reference. Further, in addition to the above-described flick operation, the CPU 11 may use, as the detection condition of the operation on the marker 65, a time period during which the finger 8 is in contact with the touch pad 17 at the time of flicking, or a movement distance of the finger 8 that is moved while being in contact with the touch pad 17.

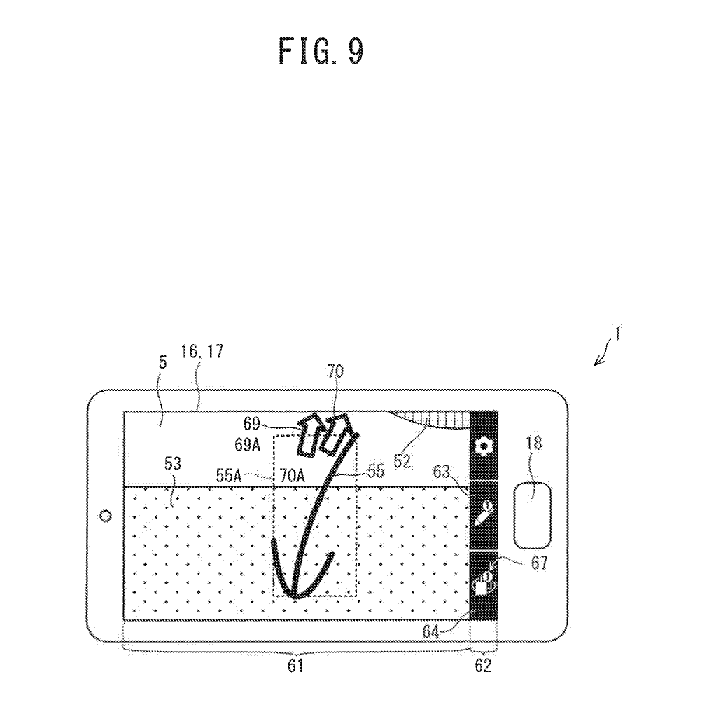

As shown in FIG. 5, the CPU 11 that has detected the operation associated with the marker 65 changes the position of the display range of the document 5 to a position where the display range includes the annotation area 55A of the annotation 55 corresponding to the marker 65 (step S25). As shown in FIG. 9, the range of the document 5 that is displayed within the display area 61 is changed to a display range 73 (shown by dotted lines in FIG. 2) that includes the annotation area 55A of the annotation 55. Normally, in the flick operation or the swipe operation, in many cases, the screen is scrolled by an amount corresponding to the magnitude or speed of the movement of the finger or the like. In the present embodiment, when the computer of each of the terminal devices detects that the flick operation or the swipe operation performed by the user is an operation on the marker, the computer reliably performs processing that changes the annotation area of the annotation corresponding to the marker to be included in the display range, regardless of the magnitude or speed of the movement of the finger or the like. As the CPU 11 performs the processing at step S25, the user can confirm the reception of the annotation data and can view the annotation 55 without scaling down and displaying the document 5.

As shown in FIG. 5, the CPU 11 deletes the marker 65 that corresponds to the annotation 55 displayed in the display area 61 of the display 16, and turns off the non-display flag for the annotation data of the annotation 55 (step S29). The CPU 11 refers to the table of the flash memory 14. When there is no annotation data for which the non-display flag is ON (no at step S31), the CPU 11 advances the processing to step S35 and repeats the processing in the same manner as that described above.

When, in the processing at step S31, there is the annotation data for which the non-display flag is ON (yes at step S31), the CPU 11 performs the sub-routine of the annotation direction display processing (step S33). In the same manner as that described above, the CPU 11 performs the annotation direction display processing shown in FIG. 7, and displays the marker that corresponds to the annotation that has not been displayed. As shown in FIG. 9, when the annotation 55 is displayed and the annotations 56 and 57 have not been displayed, the CPU 11 displays, as a marker 69, a graphic of an arrow that is directed from the center coordinates of the display range 73 (refer to FIG. 2) toward the center coordinates of the annotation area 56A. Further, the CPU 11 displays, as a marker 70, a graphic of an arrow that is directed from the center coordinates of the display range 73 toward the center coordinates of the annotation area 57A. Note that, when the position in which the marker 70 is arranged is substantially the same as the position in which the marker 69 is arranged, the CPU 11 overlays and displays a marker, which is a graphic to which a number is affixed, on the marker 69, in the same manner as that described above. After displaying the markers 69 and 70, the CPU 11 advances the processing to step S35 and repeats the processing in the same manner as that described above.

On the other hand, when the user performs the flick operation or the swipe operation that changes the position of the display range 72 in a state in which the markers 65 and 66 are displayed in the display area 61, if that operation is not the operation on the marker 65 or 66 (no at step S21, yes at step S23), the CPU 11 advances the processing to step S27. After the CPU 11 has changed the position of the display range 72 in accordance with the operation, the CPU 11 determines whether at least one of the annotation areas 55A to 57A of the annotations 55 to 57 is included in the new display range (step S27). For example, when at least one of the four corners of the annotation area 55A is included in the new display range, the CPU 11 determines that the annotation area 55A is included in the new display area. Note that, the CPU 11 may determine that the annotation area 55A is included in the new display range when two or more of the four corners of the annotation area 55A are included in the new display range. Alternatively, the CPU 11 may determine that the annotation area 55A is included in the new display range when the center coordinates of the annotation area 55A are included in the new display range. This also applies to the annotation areas 56A and 57A.

When the annotation areas 55A to 57A are not included in the new display range (no at step S27), the CPU 11 advances the processing to step S33 and performs the sub-routine of the annotation direction display processing in the same manner as that described above (step S33). The CPU 11 performs the annotation direction display processing shown in FIG. 7 in the same manner as that described above, and displays the markers that are respectively directed from the center coordinates of the new display range toward the center coordinates of the annotation areas 55A to 57A. On the other hand, when at least one of the annotation areas 55A to 57A is included in the new display range (yes at step S27), the CPU 11 advances the processing to step S29 and deletes the marker that corresponds to the annotation included in the new display range. In other words, the CPU 11 assumes that the annotation that is displayed in the display area 61 of the display 16 when the user scrolls the screen is intentionally viewed by the user, and deletes the marker that corresponds to the annotation. The CPU 11 therefore turns off the non-display flag.

As explained above, when the annotation 55 is added to an area outside the display range 72 of the document 5 that is shared between the terminal devices by the execution of the document sharing program, the CPU 11 displays the marker 65 so that the reception of the annotation data can be notified to the user. Further, when the user performs the flick operation on the marker 65, the CPU 11 changes the display range 72 of the document 5 to the display range 73 that includes the annotation area 55A so that the annotation 55 corresponding to the marker 65 can be displayed in the display area 61. The user can view the annotation 55 without performing the operation to scale up or scale down the document 5, and it is possible to reduce the trouble of performing a lot of operations in order to view the annotation 55.

In the processing at step S29, the CPU 11 deletes the marker 65 that corresponds to the annotation 55 displayed in the display area 61 of the display 16. By this processing, the user can know whether the annotations 56 and 57 that have not been displayed exist. As a result, it is possible to omit the trouble of referring to and confirming the whole of the document 5 by scaling down or scrolling the screen. Further, in the processing at step S51, the CPU 11 displays the marker that shows the result of calculating the direction in which the annotation is located. As a result, the user can know not only the reception of the annotation data, but also the direction in which the annotation is added. Further, in the processing at step S21, the CPU 11 determines whether the operation performed by the user is an operation that moves the position of the display range 72 in the direction in which the annotation 55 is displayed. By this processing, it is possible to enhance the detection accuracy of the operation on the marker 65, and it is thus possible to display the annotation 55 in the display area 61 of the display 16, as intended by the user.

Further, in the processing that is performed in the processing at step S33 and that is equivalent to the processing at step S51, the CPU 11 can determine whether the operation performed by the user is an operation that is intended to just change the display range 72 or is an operation on the marker. Therefore, it is possible to reduce the possibility that processing that is different from that intended by the user is performed. Further, in the processing that is performed in the processing at step S33 and that is equivalent to the processing at step S73, when the display range is changed in accordance with a user's operation, the CPU 11 re-calculates a positional relationship. By this processing, it is possible to display the marker that shows the direction in which the annotation is located with respect to the changed display range. Further, even when a document that is different from the document 5 to which the annotation has been added or an image etc. is displayed on the display 16, if the annotation data corresponding to the document 5 is received, the CPU 11 can notify the user of the reception of the annotation data. Therefore, the user is unlikely to overlook the annotation.

Note that the present disclosure is not limited to the above-described embodiment and various modifications are possible. For example, the CPU 11 switches the document 5 displayed in the display area 61 to another document and displays it, in response to an operation of the switch button 64. However, for example, an image or video that is captured by a camera attached to a smart phone or the like may be displayed in the display area 61, as well as the document. In response to an operation of the switch button 64, the CPU 11 may switch to display of an image etc. that is different from the document. The length of the arrow of each of the markers 65 and 66 may be changed to a length that corresponds to the magnitude (the movement distance of the display range) of the flick operation performed by the user. In the above-described embodiment, when the arrangement positions of the markers are overlaid on each other, the CPU 11 shows a number that indicates the number of the overlaid annotations, together with the arrow. However, arrows of the number of the annotations may be arranged in the display range 72 such that the arrows are distinguished from each other by colors and they are not overlaid, or even if there is some overlay, they are displaced so that they are not completely overlaid.

The server 2 need not necessarily be provided, and the terminal devices may be directly connected to each other via the network 6 and the document data stored in each of their storage devices may be shared. The annotation areas 55A to 57A are rectangles that respectively circumscribe the graphics of the annotations 55 to 57. However, each of the annotation areas 55A to 57A is not limited to a rectangle, and may be a circle, an ellipse or a polygon. Further, each of the annotation areas 55A to 57A may be, for example, a circle that circumscribes the graphic of the annotation from the center of the graphic, or may be a circle whose radius is smaller than that of the circumscribing circle. Further, each of the annotation areas 55A to 57A may be a rectangle that is a little smaller than the rectangle that circumscribes the graphic of the annotation.

What is claimed is:

1. A non-transitory computer-readable medium storing computer-readable instructions, the instructions, when executed by a processor of a terminal device, perform processes comprising:
an acquiring operation acquiring document data indicating a document being shared between a plurality of terminal devices in a remote conference;
a first displaying operation displaying, on a display device of the terminal device, a display range indicating at least a portion of the document corresponding to the acquired document data;
a receiving operation receiving annotation data from at least one of the plurality of terminal devices, the annotation data indicating an annotation superimposed on the document in the at least one of the plurality of terminal devices;
a first determining operation determining whether a position of the annotation corresponding to the received annotation data is inside the display range in the document;
a second displaying operation displaying, in response to the determination by the first determining operation that the position of the annotation is not inside the display range, a marker on the display device, the marker indicating that the annotation data has been received by the receiving operation;
a second determining operation determining whether operation information acquired from an operation device of the terminal device indicates an operation targeting the marker; and
a changing operation changing, in response to the determination by the second determining operation that the acquired operation information indicates the operation targeting the marker, the display range to include the annotation inside the display range.

2. The non-transitory computer-readable medium according to claim 1, wherein
the instructions, when executed by the processor, further perform processes comprising:
a deleting operation deleting the marker indicating the annotation inside the display range after the changing operation has changed the display range in the document to include the annotation.

3. The non-transitory computer-readable medium according to claim 1, wherein
the computer-readable instructions, when executed by the processor, further perform processes comprising:
a first comparing operation comparing the position of the display range in the document and the position of the annotation in the document, and wherein
the second displaying operation comprises displaying, based on a comparison result by the first comparing operation, the marker indicating a first direction in which the annotation is located with respect to the position of the display range.

4. The non-transitory computer-readable medium according to claim 3, wherein
the second determining operation comprises determining whether the operation information indicates an operation to move the position of the display range in the first direction, as the operation targeting the marker.

5. The non-transitory computer-readable medium according to claim 4, wherein
the second determining operation comprises determining whether the operation information indicates the movement of coordinates on the operation device along a second direction opposite to the first direction, as the operation targeting the marker.

6. The non-transitory computer-readable medium according to claim 3, wherein
the computer-readable instructions, when executed by the processor, further perform processes comprising:
a third determining operation determining whether the operation information indicates the movement of the position of the display range in the document;
a second comparing operation comparing, in response to the determination by the third determining operation that the operation information indicates the movement of the position of the display range, the position of the display range in the document and the position of the annotation; and
a third displaying operation displaying, based on a comparison result by the second comparing operation, the marker that indicates the first direction.

7. The non-transitory computer-readable medium according to claim 1, wherein
the computer-readable instructions, when executed by the processor, further perform processes comprising:
a fourth determining operation determining whether an image different from the document is displayed on the display device; and
a fourth displaying operation displaying, in response to the determination by the fourth determining that the image different from the document is displayed on the display device, the marker indicating that the annotation data has been received in an operation area displayed on the display device, the operation area being an area configured to receive an input of an operation to displays the document via the operation device.

8. A terminal device comprising:
a processor; and
a memory storing computer-readable instructions, the instructions, when executed by the processor, perform processes comprising:
an acquiring operation acquiring document data indicating a document being shared between a plurality of terminal devices in a remote conference;
a first displaying operation displaying, on a display device of the terminal device, a display range indicating at least a portion of the document corresponding to the acquired document data;
a receiving operation receiving annotation data from at least one of the plurality of terminal devices, the annotation data indicating an annotation superimposed on the document in the at least one of the plurality of terminal devices;
a first determining operation determining whether a position of the annotation corresponding to the received annotation data is inside the display range in the document;
a second displaying operation displaying, in response to the determination by the first determining operation that the position of the annotation is not inside the display range, a marker on the display device, the marker indicating that the annotation data has been received by the receiving operation;
a second determining operation determining whether operation information acquired from an operation device of the terminal device indicates an operation targeting the marker; and
a changing operation changing, in response to the determination by the second determining operation that the acquired operation information indicates the operation targeting the marker, the display range to include the annotation inside the display range.

9. A document sharing method executed by a terminal device comprising:
acquiring document data indicating a document being shared between a plurality of terminal devices in a remote conference;
first displaying, on a display device of the terminal device, a display range indicating at least a portion of the document corresponding to the acquired document data;
receiving annotation data from at least one of the plurality of terminal devices, the annotation data indicating an annotation superimposed on the document in the at least one of the plurality of terminal devices, the annotation data including position information of the annotation;
first determining whether a position of the annotation corresponding to the received annotation data is inside the display range based on the position information;
second displaying, in response to the determination by the first determining that the position of the annotation is not inside the display range, a marker on the display device, the marker indicating that the annotation data has been received by the receiving;
second determining whether operation information acquired from an operation device of the terminal device indicates an operation targeting the marker; and
changing, in response to the determination by the second determining that the acquired operation information indicates the operation targeting the marker, the display range to include the annotation inside the display range based on the position information.
